(19) United States
(12) Patent Application Publication
(10) Pub. No.: US 2023/0340384 A1
(43) Pub. Date: Oct. 26, 2023

(54) Method for Making Brandy

(71) Applicant: Erik Theodorus Maria Koster, Gendringen (NL)

(72) Inventor: Erik Theodorus Maria Koster, Gendringen (NL)

(73) Assignee: Erik Theodorus Maria Koster, Gendringen (NL)

(21) Appl. No.: 17/800,596

(22) PCT Filed: Feb. 18, 2021
(86) PCT No.: PCT/NL2021/050107

§ 371 Date: Aug. 18, 2022

(30) Foreign Application Priority Data
Feb. 19, 2020 (NL) 2024945

(51) Int. Cl. C12G 3/07; C12G 3/08; C12G 3/02; C12H 6/02; A23B 4/044; C12G 3/06

(52) U.S. Cl. CPC C12G 3/07; A23B 4/044; C12G 3/02; C12G 3/06; C12G 3/08; C12H 6/02

(57) ABSTRACT

Provided is a method for making brandy, such as for instance cognac, Armagnac or Weinbrand, including the steps of providing fermentation component for the fermentation, which fermentation component is selected from at least one of the components grapes and products made completely of grapes, such as for instance raisins; fermenting the fermentation component into an alcoholic mixture; and distilling the alcoholic mixture. Before the step of fermenting the fermentation component, the fermentation component is smoked by bringing the fermentation component into contact with smoke.

### CROSS-REFERENCE TO RELATED APPLICATIONS

This application is the U.S. National Phase of International Application No. PCT/NL2021/050107 filed Feb. 18, 2021, and claims priority to The Netherlands Patent Application No. 2024945 filed Feb. 19, 2020, the disclosures of which are hereby incorporated by reference in their entirety.

### BACKGROUND OF THE INVENTION

### Field of the Invention

The invention relates to a method for making brandy, such as for instance cognac, Armagnac or Weinbrand, comprising the steps of:
providing fermentation component for the fermentation, which fermentation component is selected from at least one of the components grapes and products made completely of grapes, such as for instance raisins;
fermenting the fermentation component into an alcoholic mixture;
distilling the alcoholic mixture.

### Description of Related Art

Brandy, its best-known variant probably being cognac, has been brewed for centuries. There are strict regulations for making the different types of brandy that have been created over time. There are for instance regulations in respect of the type of grape used, the growing region of the grape, the number of distillation steps and the duration of aging. A brandy may thus only carry the name cognac if it originates from the Cognac region, this in addition to meeting a number of other requirements.

A drawback of such regulations is that the options for obtaining a characteristic flavour palate are limited.

### SUMMARY OF THE INVENTION

It is now an object of the invention to obviate the above stated drawback, or at least to provide an alternative method of making brandy.

This object is achieved with a method characterized in that, before the step of fermenting the fermentation component, the fermentation component is smoked by bringing the fermentation component into contact with smoke.

By smoking the fermentation component, such as for instance (a mixture of) grapes or raisins, the organoleptic spectrum of the obtained final distillate is widened without the organoleptic qualities of the original distillate being lost. A cognac with a smoke flavour can thus for instance be obtained according to the method without aromatizing the cognac.

For the purpose of obtaining the desired effect the smoke used comes into contact with the fermentation component. The smoke can for instance be guided along the fermentation component.

The fermentation and distillation take place under conditions known for brandies. An Armagnac produced according to the method can thus for instance undergo a single distillation step while, according to the regulations, a cognac is distilled twice in a so-called alambic Charentais, i.e. pot still distillation kettle.

In a preferred embodiment of a method according to the invention the smoking of the fermentation component takes place at a temperature of a maximum of 25° C.

Cold smoking of the fermentation component results in no or only very limited curing of the component, and moisture is also extracted to only very limited extent. The original flavour of the fermentation component is hereby preserved as much as possible. In an embodiment of a method according to the invention the smoking of the fermentation component takes place at a temperature higher than 25° C., preferably at a temperature in the range of 60-80° C.

Hot smoking of the fermentation component makes it possible to achieve a different organoleptic spectrum in that slight curing of the component occurs. The possible moisture balance of the fermentation component also changes due to the higher temperatures, whereby a different taste sensation can also be achieved. The smoking can for instance take place at a temperature in the range of 60-80° C., since within this temperature range the fermentation component does not dry out too quickly during smoking.

In another embodiment of a method according to the invention additional fermentation component is added after the step of smoking, which additional fermentation component is selected from at least one of the components grapes and products made completely of grapes, such as for instance raisins or grape juice, which additional fermentation component is not smoked.

The degree of smoke flavour in the final product can be varied by the addition, after smoking of the fermentation component, of additional, unsmoked, fermentation component.

The additional fermentation component can for instance be added before the step of fermenting.

Also according to the invention is an embodiment of a method wherein the smoke comes from wood.

Smoke from smouldering or burning wood has good organoleptic qualities for the brandy, whereby a pleasant taste sensation can be effected in a user. Wood types such as cherry, apple, birch, beech, oak, maple, hickory or pecan can for instance be used for the smoking. A distinctive flavour profile can also be obtained with combinations of wood types.

Another embodiment of a method according to the invention is a method wherein the smoke comes from peat.

Smoke from smouldering or burning peat has good organoleptic qualities for the brandy, whereby a pleasant taste sensation can be effected in a user. It is also possible to opt for a combination of peat smoke and wood smoke.

### BRIEF DESCRIPTION OF THE DRAWINGS

These and other features of the invention are further elucidated with reference to the accompanying drawing.

FIG. 1 shows a flow diagram of a method according to the invention.

### DESCRIPTION OF THE INVENTION

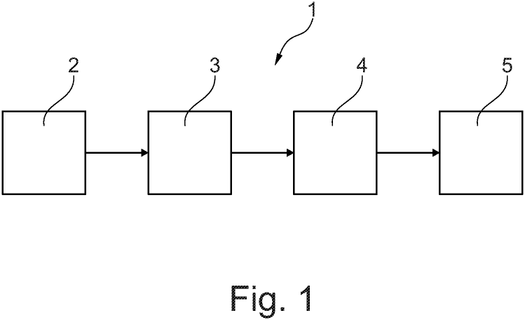

FIG. 1 shows a flow diagram 1 of a method according to the invention. In a first step 2 fermentation component is provided. The fermentation component is smoked in a second step 3. In a third step 4 the component is fermented into an alcoholic mixture, which is distilled in the fourth step 5. Unsmoked additional fermentation component can optionally be added, for instance between the second step 3 and the third step 4.

1. A method for making brandy, such as for instance cognac, Armagnac or Weinbrand, comprising the steps of:
providing fermentation component for the fermentation, which fermentation component is selected from at least one of the components grapes and products made completely of grapes, such as for instance raisins;
fermenting the fermentation component into an alcoholic mixture; and
distilling the alcoholic mixture,
wherein, before the step of fermenting the fermentation component, the fermentation component is smoked by bringing the fermentation component into contact with smoke.

2. The method according to claim 1, wherein the smoking of the fermentation component takes place at a temperature of a maximum of 25° C.

3. The method according to claim 1, wherein the smoking of the fermentation component takes place at a temperature higher than 25° C., preferably at a temperature in the range of 60-80° C.

4. The method according to claim 1, wherein additional fermentation component is added after the step of smoking, which additional fermentation component is selected from at least one of the components grapes and products made completely of grapes, such as for instance raisins or grape juice, which additional fermentation component is not smoked.

5. The method according to claim 1, wherein the smoke comes from wood.

6. The method according to claim 1, wherein the smoke comes from peat.
